(19) United States
(12) Patent Application Publication
(10) Pub. No.: US 2005/0169135 A1
(43) Pub. Date: Aug. 4, 2005

(54) Recording apparatus, recording method, and information recording medium

(75) Inventors: Sung-hee Hwang, Seoul (KR); Jung-wan Ko, Suwon-si (KR)

Correspondence Address: Stein, McEwen & Bui LLP, Suite 300, 1400 Eye Street, N.W., Washington, DC, 20005, US

(73) Assignee: Samsung Electronics Co., Ltd., Suwon-si (KR)

(21) Appl. No.: 11/002,989

(22) Filed: Dec. 3, 2004

(30) Foreign Application Priority Data
Dec. 5, 2003 (KR) 2003-88169

(51) Int. Cl. G11B 5/09

(52) U.S. Cl. 369/47.21; 369/59.25

(57) ABSTRACT

A recording apparatus including a unit that records data and/or reads data from a medium including a lead-in area, a data area having a user data area where user data is recorded and a spare where replacement data for updating the user data is recorded, and a lead-out area; and a controller that controls the unit to record the replacement data in the spare area according to a replacement enforcement write command received from a host that instructs the recording of replacement data in the spare area.

### CROSS-REFERENCE TO RELATED APPLICATION

This application claims the priority of Korean Patent Application No. 2003-88169, filed on Dec. 5, 2003, in the Korean Intellectual Property Office, the disclosure of which is incorporated herein by reference.

### BACKGROUND OF THE INVENTION

1. Field of the Invention

The invention relates to a recording apparatus for recording data on an optical information recording medium, a recording method, and an information recording medium.

2. Description of the Related Art

Data cannot be overwritten to write-once media due to their characteristic of once-writing. Thus, a specific recording method, such as a disc-at-once recording method, a track-unit sequential recording method, or the like, has been used for the write-once media.

FIG. 1 illustrates a conventional method of recording a file system on a write-once information recording medium. For example, as shown in FIG. 1, data may be recorded on the write-once information recording medium as shown in FIG. 1. In other words, when a first file system 110 is recorded in a first position of a write-once information recording medium 100, and then first data 120 is recorded, a second file system 130, which is updated by reading the recording of the first data 120, is recorded next to the first data 120. Similarly, when second data 140 is recorded next to the second file system 130, a third file system 150, which is updated by reading the recording of the second data 140, is recorded next to the second data 140. Thus, information relating to a file system is located in several areas of a conventional write-once information recording medium, which causes a reproduction velocity to be slower.

A command to record data on an information recording medium is generally classified into two classes: a write command to record simple data and a verify-after-write command to verify data after recording data for the reliability of data. The verify-after-write command is executed with respect to data requiring high reliability, such as file system data. This is because reproduction cannot be performed with respect to an entire information recording medium when a file system file cannot be reproduced. Thus, when it is determined that the reliability of data is deteriorated through a verification procedure after the data is written, the verify-after-write command is executed to secure the reliability of the data using a defect management method.

However, in a case where a host desires to update data in a recorded area of a write-once information recording medium, the host cannot update the data using only the two commands. Therefore, a method of updating data on the write-once information recording medium, similar to a method used on a rewriting information recording medium, is required.

### SUMMARY OF THE INVENTION

The invention provides a recording apparatus for updating data while fixing a logical address of the data, a recording method, and an information recording medium.

According to an aspect of the invention, there is provided a recording apparatus including: a writing and/or reading unit which records data and/or reads data from an information recording medium having a lead-in area, a data area including a user data area in which user data is recorded and a spare area in which replacement data for updating the user data is recorded, and a lead-out area; and a controller which controls the writing and/or reading unit to record the replacement data in the spare area according to a replacement enforcement write command received from a host which instructs recording of the replacement data in the spare area.

According to an aspect of the invention, the controller controls the writing and/or reading unit to record a defect list, which includes information as to a physical address of the user data recorded in the user data area and information as to a physical address of the replacement data recorded in the spare area on the information recording medium.

According to an aspect of the invention, the spare area is expandable.

According to an aspect of the invention, the user data includes file system data.

According to another aspect of the invention, there is provided a host for controlling a recording apparatus to record data on an information recording medium having a lead-in area, a data area including a user data area in which user data is recorded and a spare area in which replacement data for updating the user data is recorded, and a lead-out area. The recording apparatus includes a controller which controls the host to transmit a replacement enforcement write command so as to instruct recording of the replacement data in the spare area.

According to another aspect of the invention, there is provided a recording method including: receiving a replacement enforcement writ command from a host which instructs recording of replacement data for updating user data recorded in a user data area of an information recording medium in a spare area of the information recording medium; and recording the replacement data in the spare area according to the replacement enforcement write command.

According to another aspect of the invention, there is provided a method of controlling a recording apparatus to record data on an information recording medium having a lead-in area, a data area including a user data area in which user data is recorded and a spare area in which replacement data for updating the user data is recorded, and a lead-out area, having: controlling a host, which instructs recording of the replacement data in the spare area, to transmit a replacement enforcement write command.

According to another aspect of the invention, there is provided an information recording medium including: a lead-in area; a data area including a user data area in which user data is recorded and a spare area in which replacement data for updating the user data is recorded; and a lead-out area. Here, the replacement data is recorded in the spare area according to a replacement enforcement write command received from a host which instructs recording of the replacement data in the spare area.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional method of recording a file system on a write-once information recording medium;

FIG. 2 is a schematic block diagram of a recording and/or reproducing apparatus, according to an embodiment of the invention;

FIG. 3 is a detailed block diagram of the recording and/or reproducing apparatus of FIG. 2;

FIG. 4 is a referential view illustrating a disk area to which the invention is applied;

FIGS. 5A through 5D are views illustrating a disk area in which a write operation is performed according to a replacement enforcement write command of the invention;

FIGS. 6A and 6B are views illustrating a defect list, according to an aspect of the invention;

FIGS. 7A and 7B are referential views illustrating a direction in which a disk area is used while recording is performed according to the replacement enforcement write command of the invention;

FIG. 8 is a flowchart illustrating a recording operation performed according to the replacement enforcement write command of the invention; and

FIG. 9 is a flowchart illustrating a data adding operation performed according to the replacement enforcement write command of the invention.

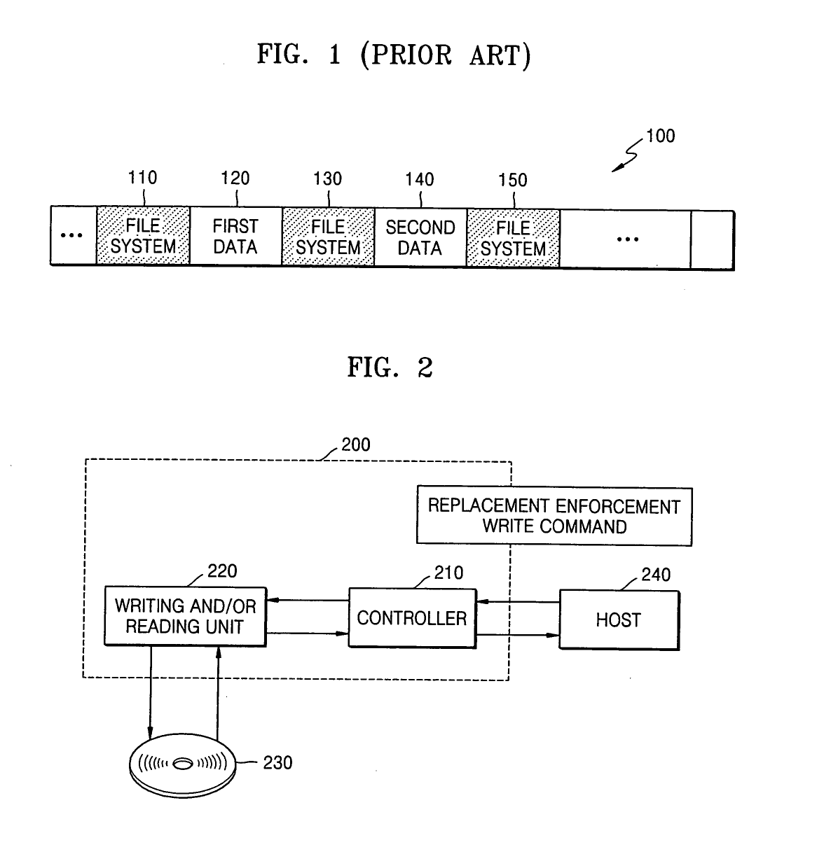

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a schematic block diagram of a recording and/or reproducing apparatus, according to an aspect of the invention. Referring to FIG. 2, a recording and/or reproducing apparatus 200 performs recording and/or reproduction and includes a writing and/or reading unit 220 and a controller 210. The writing and/or reading unit 220 records data from a disk 230, which is an information recording medium, and/or reads data from the disk 230 to reproduce the data under the control of the controller 210. The controller 210 controls the writing and/or reading unit 220 to record data in each predetermined recording unit block or processes data that is read by the writing and/or reading unit 220 to obtain effective data.

During a recording operation, the controller 210 receives a replacement enforcement write command from a host 240 and controls the writing and/or reading unit 220 to record data according to a replacement enforcement write command. The replacement enforcement write command updates data recorded on the disk 230 using a disk defect management method.

The disk defect management method manages disk defects to improve the reliability of data recorded on the disk. The disk defect management method is classified into a slipping replacement method and a linear replacement method. In the slipping replacement method, a defect detected in an initial process for using the disk is processed. In the linear replacement method, an error correction code (ECC) block including a defective sector in which a defect occurs during the use of the disk is replaced with a non-defective ECC block of a spare area.

For example, in the slipping replacement method, a defective sector having a defect detected in a verification process for checking disk defects during initialization of the disk is not assigned a logical sector number. The logical number of the defective sector is assigned to a sector next to the defective sector. As a result, a reduction in a recording or reproduction velocity caused by the defect is reduced by slipping the defective sector during recording or reproduction of data.

However, when the defect occurs during the use of the disc, the slipping replacement method cannot be used because logical sector numbers are inconsecutively assigned due to slipping of the defective sector. Thus, the linear replacement method is used for the defect occurring during the use of the disk in order to replace the ECC block having the defective sector with the ECC block of the spare area.

When the controller 210 executes the replacement enforcement write command received from the host 240, one of the above-described defect management methods may be used The foregoing procedure will be explained in detail below.

During reproduction, the controller 210 controls the writing and/or reading unit 220 to record data using a file system recording method that has been used with respect to the disk 230. For example, the controller 210 controls the writing and/or reading unit 220 to read defect list information that is stored in a predetermined portion of the disk 230 to detect a physical position in which data is stored so that data can be read from the physical position.

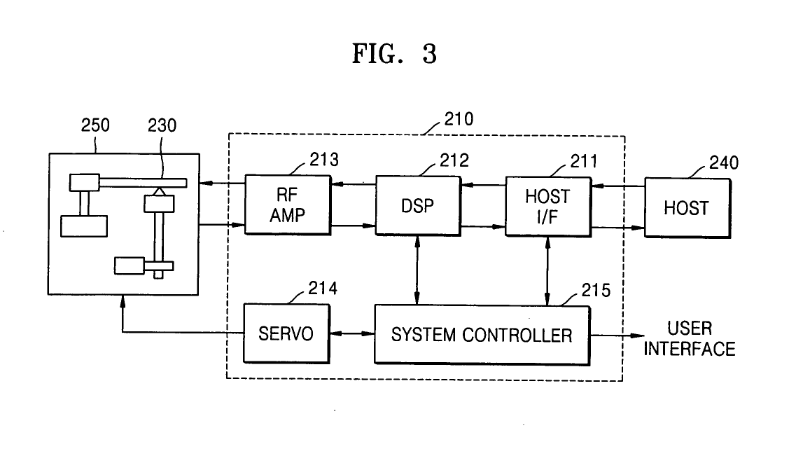

FIG. 3 is a detailed block diagram of the recording and/or reproducing apparatus of FIG. 2. Referring to FIG. 3, a disk drive (the recording and/or reproducing apparatus) includes a pickup 250 as the writing and/or reading unit 220. The disk 230 is mounted in the pickup 250. The disk drive also includes the controller 210 including a host interface (I/F) 211, a digital signal processor (DSP) 212, a radio frequency amplifier (RF AMP) 213, a servo 214, and a system controller 215.

During recording, the host I/F 211 receives the replacement enforcement write command from the host 240, along with data to be updated and information relating to a logical address of the data and transmits the replacement enforcement write command to the system controller 215.

The system controller 215 receives the replacement enforcement write command from the host I/F 211 in order to perform an initial process for recording. In particular, the system controller 215 analyzes the replacement enforcement write command and controls the performance of recording according to the analyzed replacement enforcement write command. For example, when the system controller 215 receives the replacement enforcement write command, the system controller 215 searches for an address of an area in which the data to be updated is to be recorded, i.e., an unused area, and controls the DSP 212 and the servo 214 to record the data to be updated in the address. After the recording of the data to be updated is completed, the system controller 215 generates a defect list, which includes information relating to a physical address in which the data to be updated is recorded (even when the data has been updated several times according to the replacement enforcement write command) and information relating to a physical address in which the updated data is recorded, and controls the recording of the defect list in a predetermined area of the disk 230.

As described above, according to the replacement enforcement write command of the invention, when data is updated, a table for managing a changed physical address may be provided without changing a logical address of the data. As a result, information relating to the data may be obtained from a fixed position of a rewrite information recording medium.

The DSP 212 receives data to be recorded from the host I/F 211, adds additional data, such as a parity bit or the like, to the data for error correction, performs ECC encoding on the data, generates an ECC block, and modulates the ECC block using a predetermined method. The RF AMP 213 converts data output from the DSP 212 into an RF signal. The pickup 250 records the RF signal output from the RF AMP 213 on the disk 230. The servo 214 receives a servo control command from the system controller 215 to servo control the pickup 250.

For reproduction, the host I/F 211 receives a reproduction command from the host 240. The system controller 215 performs an initial process for reproduction. In particular, the system controller 215 controls reading of the defect list recorded in a predetermined area of the disk 230, obtains information as to a physical position in which data is recorded from the defect list, and controls reproduction of data from the physical position.

The pickup 250 irradiates a laser onto the disk 230 and receives the reflected laser beam reflected from the disk 230 to output a light signal. The RF AMP 213 converts the light signal output from the pickup 250 into an RF signal and provides modulated data obtained from the RF signal to the DSP 212 and a servo control signal obtained from the RF signal to the servo 214. The DSP 212 demodulates the modulated data and outputs data obtained by performing ECC encoding on the demodulated data.

The servo 214 servo controls the pickup 250 according to the servo control signal and the servo control command respectively received from the RF AMP 213 and the system controller 215. The host I/F 211 receives data from the DSP 212 and transmits the data to the host 240.

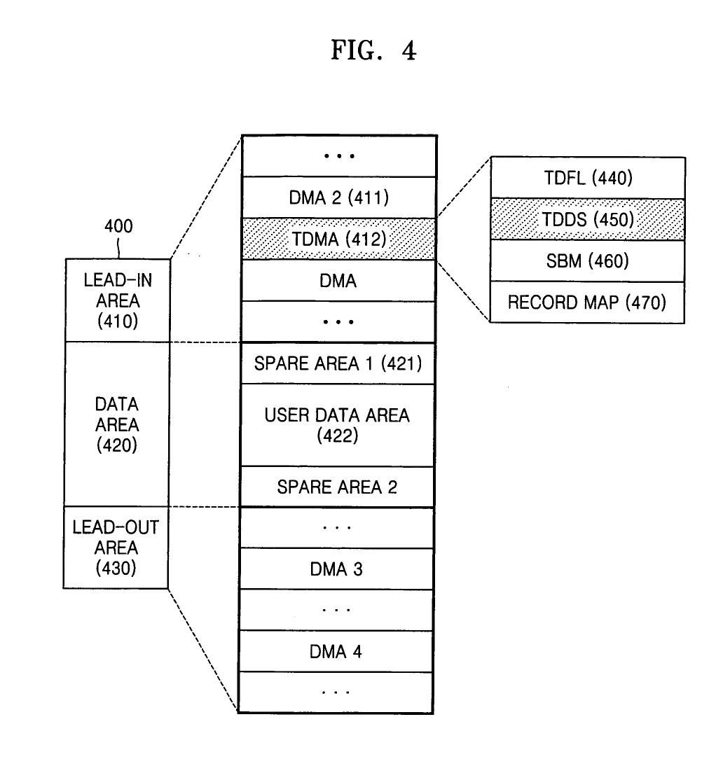

FIG. 4 is a view for illustrating the configuration of data recorded on a write-once information recording medium according to the replacement enforcement write command. Referring to FIG. 4, a write-once information recording medium 400 includes a lead-in area 410, a data area 420, and a lead-out area 430.

The lead-in area 410 includes disk management area 2 (DMA 2) 411, a temporary DMA (TDMA) 412, and so on.

The TDMA 412 refers to an area in which temporary defect management information and temporary disk management information for managing the write-once information recording medium 400 is recorded.

The TDMA 412 includes a temporary defect list (TDFL) 440, a temporary disk definition structure (TDDS) 450, a space bit map (SBM) 460, and a record map 470.

The TDFL 440 includes a defect list including information as to the status of a defect, information as to a position of a defective sector, and information as to a position of a replacement sector. For example, the information as to the position of the defective sector indicates a physical position in which data is first recorded, and the information as to the position of the replacement sector indicates a physical position in which updated data is recorded.

The TDDS 450 includes position pointers of the TDFL 440, the SBM 460, and the record map 470. The TDDS 450 also includes information as to position and size of a spare area allocated during initialization, write protection information, information as to position and size of a temporary defect management area allocated to the data area 420, information as to a user data area, information as to replaceable positions of each spare area, a last recorded address of the user data area, and the like.

The SBM 460 indicates whether recording is performed with respect to each cluster of the user data area, using a bit value.

The record map 470 indicates whether data is recorded in several areas into which the user data area is divided, using entry information. The entry information includes information as to a status, a start address, and a last address of the user data area. Thus, information as to an area designated by an entry indicates the recording status of the user data area. The information as to the status of the user data area includes information for indicating whether data is recorded in the area and usable.

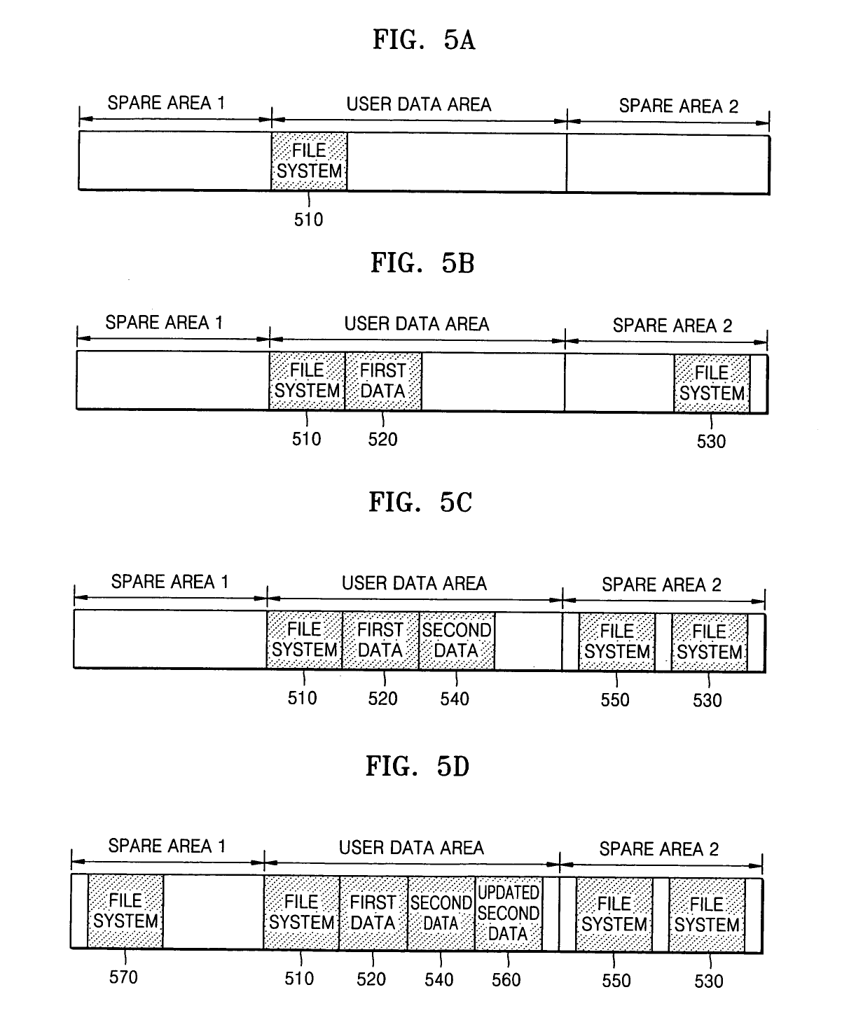

FIGS. 5A through 5D are illustrations of a disk area in which file system data is recorded according to the replacement enforcement write command.

Referring to FIG. 5A, a file system 510 for managing user data is allocated to a fixed position of a user data area to record an initial file system. The first position may be a fixed position.

As shown in FIG. 5B, when first data 520 is recorded in the user data area, the file system 510 is updated as a file system 530 by reflecting the first data 520. Here, a host commands to record the updated file system 530 using the replacement enforcement write command. The file system 530 is then recorded in spare area 2 using a type of disk defect management method as if the file system 510 were replaced with the file system 530 due to a defect. The type of disk defect management method may be a linear replacement method. Information relating to positions of the files systems 510 and 530 is recorded in a defect list.

As shown in FIG. 5C, when second data 540 is recorded in the user data area, the file system 530 is updated as a file system 550 according to the replacement enforcement write command, and the file system 550 is recorded in the spare area 2 using the disk defect management method, such as the linear replacement method. Information relating to positions of the file systems 510 and 550 is recorded in the defect list.

As shown in FIG. 5D, when updated second data 560 is recorded in the user data area, the file system 550 is updated as a file system 570 according to the replacement enforcement write command, and then the file system 570 is recorded in spare area 1 using the linear replacement method. Here, only information as to positions of the file systems 510 and 570 is recorded in the defect list. The defect list will be explained in more detail later. The file systems 530, 550, and 570 are not restricted to being recorded in any one of spare areas 1 or 2.

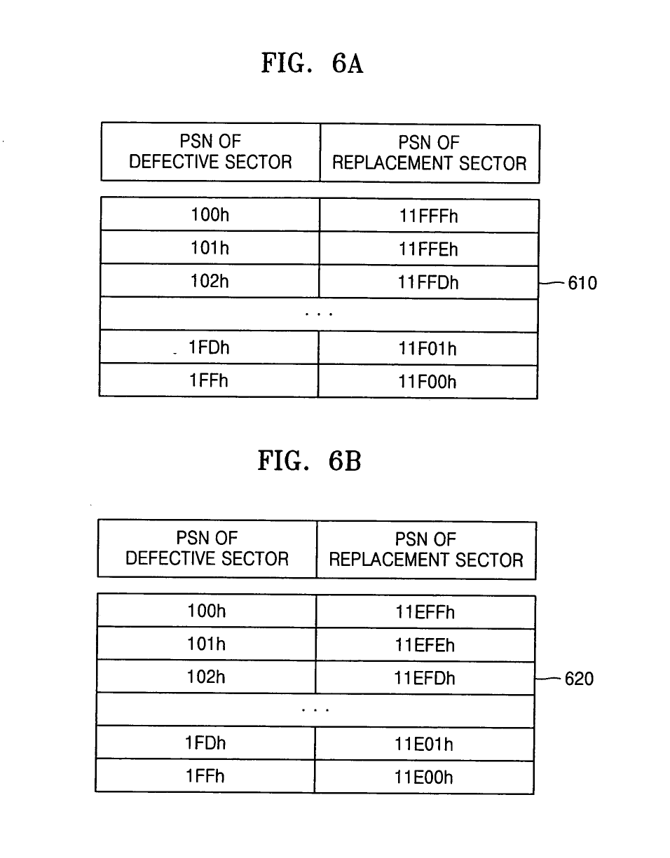

FIGS. 6A and 6B illustrate a defect list, according to an aspect of the invention.

An example of a defect list recorded under the control of the controller 210 will be described with reference to FIGS. 6A and 6B.

For example, when a physical sector number of a user data area corresponding to logical sector number 00h-FFh is 100h-FFh (an area of FIG. 5A in which the file system 510 is recorded), and data corresponding to the logical sector number 00h-FFh is updated in physical sector number 11FFh-11F00h (an area in which the file system 530 is recorded) of a spare area according to the replacement enforcement write command, a defect list 610 including information as to a defective sector and a replacement sector is constructed as shown in FIG. 6A.

When a defect list 620 is constructed according to a first replacement enforcement write command, and the data corresponding to the logical sector number 00h-FFh is updated in physical sector number 11 EFFh-11E00h of the spare area according to a second replacement enforcement write command, the defect list 620 including information as to the defective sector and the replacement sector is as shown in FIG. 6B. Thus, a file system may be detected from a fixed logical sector number by searching the defect list 620 including a physical sector number corresponding to a logical sector number using the logical sector number.

As described above, when data is updated, a logical sector number of file system data may be set by updating a file system using a disk management method to obtain an address of the file system from a fixed position.

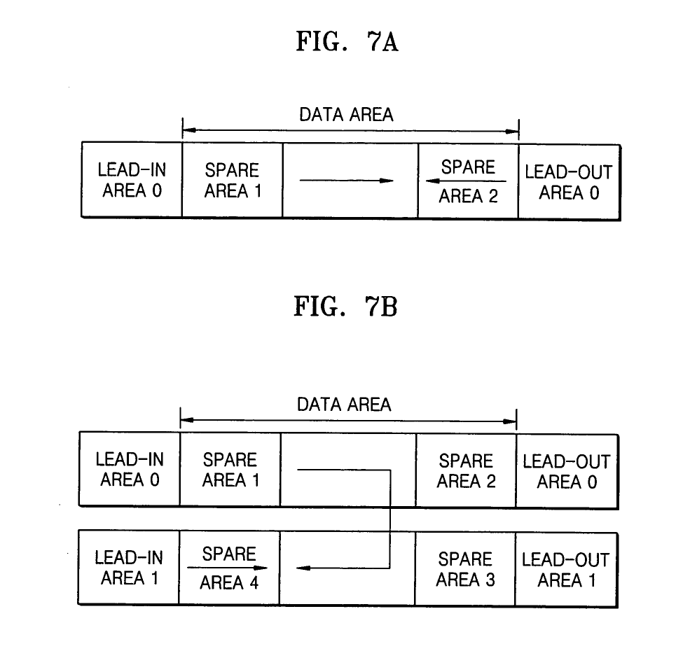

FIG. 7A illustrates a direction in which a single-layer disk area is used when recording is performed according to the replacement enforcement write command of the invention, and FIG. 7B is a referential view for explaining a direction in which a dual-layer disk area is used when recording is performed according to the replacement enforcement write command of the invention.

A plurality of spare areas are required for a drive to execute a replacement enforcement write command from a host. Thus, a spare area may be secured during an initialization operation or expanded when necessary. Therefore, since the drive cannot determine how many replacement enforcement write commands the drive receives from the host, the information recording medium may have a structure in which a spare area is expanded.

Referring to FIG. 7A, when an information recording medium is used from a lead-in area 0 toward a lead-out area 0, a spare area 2 is used from a position close to the lead-out area 0 to be expanded.

Referring to FIG. 7B, when the information recording medium is used from the lead-in area 0 toward the lead-out area 0 and then through lead-out area 1 toward lead-in area 1, spare area 4 is used from a position close to the lead-in area 1 to be expanded.

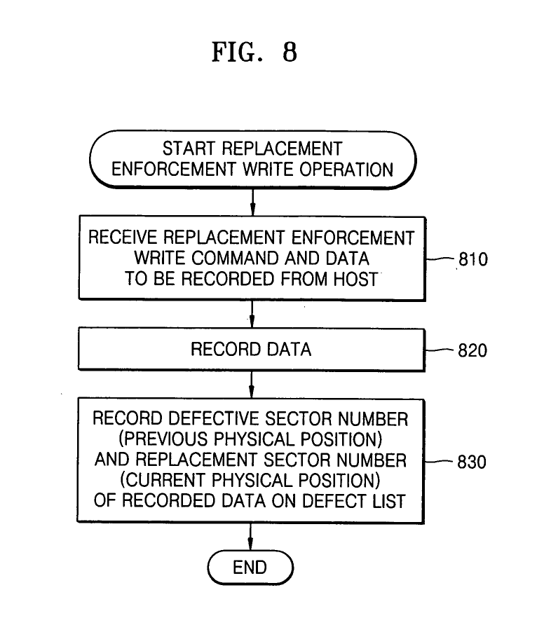

FIG. 8 is a flowchart illustrating a recording operation performed according to the replacement enforcement write command of the invention. Referring to FIG. 8, in operation 810, a drive receives a replacement enforcement write command and recording data from a host. For example, a host I/F of the drive receives the replacement enforcement write command, data to be updated, and information as to a logical address of the data to be updated and transmits the replacement enforcement write command and the information as to the logical address to a system controller.

In operation 820, the system controller transmits information of a physical address of the unused area to a servo to control the servo to detect a position of the unused area and controls a DSP to process and record the data to be updated.

The system controller generates the defect list as if the data were updated due to a defect. The defect list includes defective sector numbers and replacement sector numbers. According to the invention, the system controller generates the defect list by including information as to a physical address in which the updated data is first recorded as information as to a defective sector and information as to a physical address in which currently updated data is recorded as information as to a replacement sector.

In operation 830, the system controller controls recording of the defect list in a TDMA of a lead-in area.

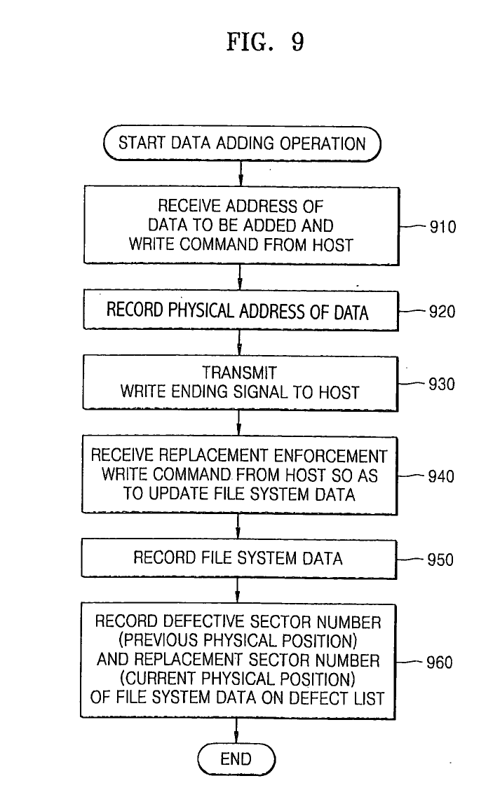

FIG. 9 is a flowchart illustrating a file system updating operation performed according to a replacement enforcement write command by reflecting additional data to be recorded. Referring to FIG. 9, in operation 910, a host transmits a write command, data to be additionally recorded, and information of an address that the data is additionally recorded to a drive.

In operation 920, a host I/F of the drive transmits the write command and the information of the address to a system controller, and the system controller controls a DSP and a servo to record data in a physical position designated by the information as to the address.

In operation 930, the system controller transmits a write ending signal to the host via the host I/F.

In operation 940, the host transmits a replacement enforcement write command to the drive so as to update file system data when there is an additional recording of the data.

The host I/F of the drive receives the replacement enforcement write command, the file system data to be updated, and information as to a logical address of the file system data from the host, and transmits the replacement enforcement write command and the information of the logical address to the system controller.

When the system controller receives the replacement enforcement write command, the system controller searches a defect list recorded in a lead-in area for an unused area of a spare area. In operation 950, the system controller transmits information of a physical address of the unused area to the servo to control the servo to detect a position of the unused area and controls the DSP to process and record to the file system data.

The system controller generates the defect list as if the data were updated due to a defect. The defect list includes defective sector numbers and replacement sector numbers. The system controller generates the defect list by including information of a physical address in which the file system data is first recorded as information of a defective sector and information as to an address in which the updated file system data is recorded as information of a replacement sector. For example, the information of the physical address may be obtained by transforming the information of the logical address transmitted together with the replacement enforcement write command.

In operation 960, the system controller controls recording of the defect list in a TDMA of the lead-in area. For example, the system controller transmits information of a position of the TDMA of the lead-in area in which the defect list is to be recorded to the servo and transmits data of the defect list to the DSP to control recording of the defect list.

As described above, in a recording apparatus, a recording method, and an information recording medium, data can be updated on a write-once information recording medium while fixing a logical address of data recorded in a user data area. Thus, a host can easily manage and update data.

In particular, even on a write-once information recording medium such as DVD-R/DVD+R, a replacement enforcement write command makes searching for information of a file system much easier. As a result, the performance of a system can be improved.

Repeated rewriting of information on a rewrite information recording medium deteriorates the characteristics of the rewrite information recording medium, which reduces data reliability. Thus, rewriting is limited to a predetermined number of times. A number of times rewriting is performed must be counted after the predetermined number of times. However, rewriting can be performed using a replacement enforcement write command. Further, although the updated data is referred to as file system data, the updated data is not limited to file system data. It will be understood by those of ordinary skill in the art that a recording method of the invention can be applied to user data.

The invention can be embodied as computer readable codes on a computer readable recording medium capable of being read by at least one computer. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

1. A recording apparatus comprising:
a unit that writes data and/or reads data from a medium comprising a user data area in which user data is recorded and a spare area in which replacement data for updating the user data is recorded;
a host that instructs writing of replacement data in the spare area; and
a controller that controls the unit to write the replacement data in the spare area according to a replacement enforcement write command received from the host.

2. The recording apparatus of claim 1, wherein the controller further controls the unit to write a defect list comprising information of a physical address of the user data recorded in the user data area and information of a physical address of the replacement data recorded in the spare area on the medium.

3. The recording apparatus of claim 1, wherein the spare area is expandable to store additional replacement data.

4. The recording apparatus of claim 1, wherein the user data comprises file system data for managing user data.

5. A unit for controlling a recording apparatus to record data on a medium comprising:
a controller that controls transmitting a replacement enforcement write command, which instructs recording replacement data in a spare area, to the recording apparatus to record data on the medium,
wherein the medium comprises a user data area in which user data is recorded and a spare area in which replacement data for updating the user data is recorded.

6. A method of recording data on a medium using a recording apparatus, comprising:
receiving a replacement enforcement write command to control recording of updated user data when updating user data recorded in a user data area of the medium; and
recording the replacement data in a spare area of the medium according to the replacement enforcement write command.

7. The method of recording data of claim 6, wherein the recording of the replacement data in the spare area comprises:
recording a defect list comprising information of a physical address of the user data recorded in the user data area and information of a physical address of the replacement data recorded in the spare area on the medium.

8. The method of recording data of claim 6, wherein the spare area is expandable to store additional replacement data.

9. The method of recording data of claim 6, wherein the user data comprises file system data for managing user data.

10. A method of controlling a recording apparatus to record data on a medium, the method comprising:
controlling a host, which instructs recording of the replacement data in a spare area, to transmit a replacement enforcement write command, which instructs recording of the replacement data in the spare area, to the recording apparatus to record data on the medium comprising a user data area where user data is recorded and the spare area where replacement data for updating the user data is recorded.

11. A medium to be read by a recording apparatus, the medium comprising:
a data area comprising a user data area where user data is recorded and a spare area where replacement data for updating the user data is recorded,
wherein the replacement data is recorded in the spare area according to a replacement enforcement write command received from a host of the recording apparatus that instructs recording of the replacement data in the spare area.

12. A write-once information storage medium to be read by a recording apparatus, the write-once information storage medium comprising:
a first area storing at least one block of user data to be read by the recording apparatus;
a second area storing at least one system information file corresponding to the at least one block of user date stored in the first area, respectively; and
a management area storing management information for the write-once information storage medium comprising positional information of the at least one block of user data and the corresponding at least one system information file.

13. A method of recording file system data on at least one write-once information storage medium to be read by a recording apparatus, the method comprising:
recording at least one block of user data to be read by the recording apparatus in a first area;
recording at least one system information file corresponding to the at least one block of user date in a second area, respectively; and
recording management information for the at least one write-once information storage medium comprising positional information of the at least one block of user data and the corresponding at least one system information file in a management area.
